(19) United States
(12) Patent Application Publication
(10) Pub. No.: US 2023/0092125 A1
(43) Pub. Date: Mar. 23, 2023

(54) MEMORY SYSTEM

(71) Applicant: KIOXIA CORPORATION, Tokyo (JP)

(72) Inventor: Shintaro HABA, Kawasaki Kanagawa (JP)

(21) Appl. No.: 17/682,853

(22) Filed: Feb. 28, 2022

(30) Foreign Application Priority Data
Sep. 21, 2021 (JP) 2021-153154

(51) Int. Cl. G06F 3/06

(52) U.S. Cl. CPC G06F 3/0659; G06F 3/0632; G06F 3/0604; G06F 3/0679

(57) ABSTRACT

According to one embodiment, a memory system that is connectable to a host includes a nonvolatile memory and a controller. The controller is configured to generate an identifier of a data object to be written in response to a write command from a host, then transmit the identifier to the host. The controller causes the data of the data object to be stored in the nonvolatile memory and maintains a table providing a correspondence between the identifier and a storage position for the data of the data object in the nonvolatile memory.

### CROSS-REFERENCE TO RELATED APPLICATION(S)

This application is based upon and claims the benefit of priority from Japanese Patent Application No. 2021-153154, filed Sep. 21, 2021, the entire contents of which are incorporated herein by reference.

### FIELD

Embodiments described herein relate generally to a memory system.

### BACKGROUND

A device including a nonvolatile memory that stores a data object is known.

### BRIEF DESCRIPTION OF THE DRAWINGS

FIG. 1 depicts a memory system according to an embodiment.

FIG. 2 is a diagram illustrating information stored in a dynamic random access memory (DRAM) according to an embodiment.

FIG. 3 is a diagram illustrating aspects related to object information according to an embodiment.

FIG. 4 is a diagram illustrating a data structure of object allocation table information according to an embodiment.

FIG. 5 depicts aspects related to a method for specifying data of a data object corresponding to object information in an embodiment.

FIG. 6 depicts a data cache memory according to an embodiment.

FIG. 7 is a sequence diagram illustrating an operation in response to a write command according to an embodiment.

FIG. 8 is a sequence diagram illustrating an operation in response to another write command according to an embodiment.

FIG. 9 is a sequence diagram illustrating an operation in response to a read command in the case of a cache hit mistake according to an embodiment.

FIG. 10 is a sequence diagram illustrating an operation in response to a read command when there is no cache hit according to an embodiment.

FIG. 11 is a sequence diagram illustrating an operation in response to a remove command according to an embodiment.

FIG. 12 is a sequence diagram illustrating an operation in response to a format command according to an embodiment.

FIG. 13 is a flowchart illustrating control related to a master boot record according to an embodiment.

FIG. 14 is a diagram illustrating a data structure of object allocation table information according to a modification.

FIG. 15 is a diagram illustrating aspects related to a method for specifying data of a data object corresponding to object information according to a modification.

### DETAILED DESCRIPTION

Embodiments provide a memory system capable of appropriately performing processing in units of data objects.

In general, according to one embodiment, a memory system that is connectable to a host includes a nonvolatile memory and a controller. The controller is configured to generate an identifier of a data object to be written in response to a write command from a host, then transmit the identifier to the host. The controller is configured to store the data of the data object in the nonvolatile memory and maintain a table providing a correspondence between the identifier and a storage position for the data of the data object in the nonvolatile memory.

Hereinafter, a memory system according to certain example embodiments will be described with reference to the accompanying drawings. The present disclosure is not limited to these example embodiments.

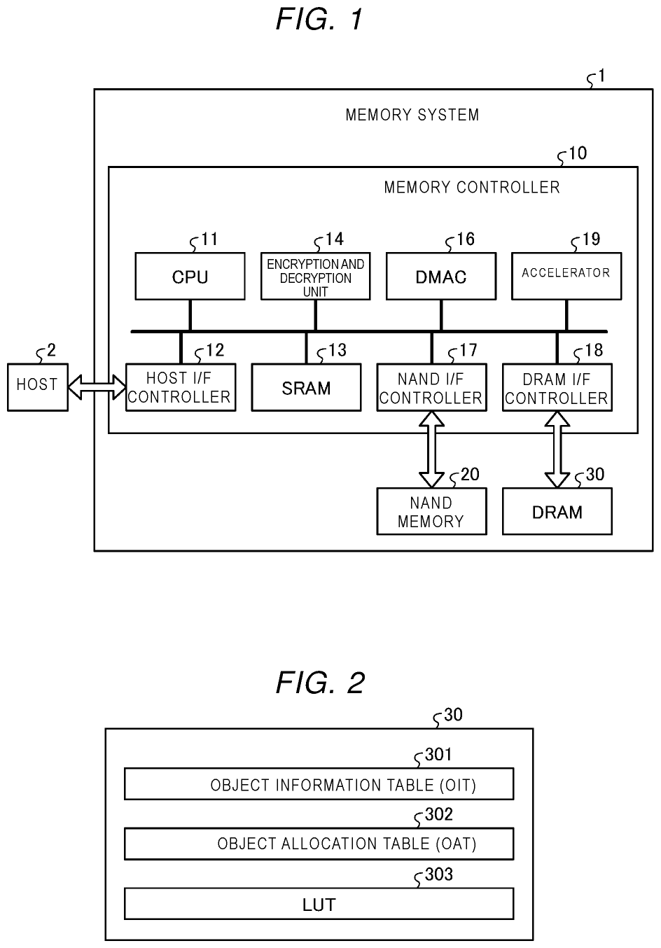

FIG. 1 is a diagram illustrating an example of a configuration of a memory system 1 according to an embodiment. As shown in FIG. 1, the memory system 1 includes a memory controller 10, a NAND flash memory 20 (also referred to as “NAND memory 20”), and a DRAM 30. The memory system 1 can be a solid-state drive (SSD) including the NAND memory 20 as nonvolatile memory.

The memory controller 10 may be configured as, for example, a system on a chip (SoC). In addition, the memory controller 10 may include or comprise a field programmable gate array (FPGA) or an application specific integrated circuit (ASIC). The memory controller 10 can instruct the NAND memory 20 and the DRAM 30 to perform various operations. The memory controller 10 executes operations based on a command from an external host 2 but also some operations not requiring a command from the host 2.

The memory controller 10 includes a central processing unit (CPU) 11, a host interface (I/F) controller 12, a static random access memory (SRAM) 13, an encryption/decryption unit 14, a direct memory access controller (DMAC) 16, a NAND I/F controller 17, a DRAM I/F controller 18, and an accelerator 19. Although the DRAM 30 is provided outside the memory controller in FIG. 1, the DRAM 30 may be provided inside the memory controller 10 in other examples.

The CPU 11 controls overall operations of the memory controller 10. The CPU 11 controls transfer of data between the host 2 and the NAND memory 20 and manages a storage position of data in the NAND memory 20. The CPU 11 interprets a command received from the host 2, and executes processing requested by the command by controlling other units within the memory controller 10.

The host I/F controller 12 is connected to the host 2 and handles communication between the memory system 1 and the host 2. The host I/F controller 12 controls, for example, transfer of data, transfers of requests, and transfers of addresses between the memory system 1 and the host 2. The host I/F controller 12 performs processing in accordance with a communication interface standard or the like. The host I/F controller 12 receives a command signal from the host 2.

The SRAM 13 functions as a work area of the CPU 11. The SRAM 13 is also used as a cache memory for commands from the host 2 and data being transferred between the host 2 and the NAND memory 20.

The encryption/decryption unit 14 encrypts write data written in the NAND memory 20 as necessary. In addition, the encryption/decryption unit 14 decrypts encrypted data read from the NAND memory 20 as necessary.

The DMAC 16 is a device that transfers user data between the host I/F controller 12 and the NAND I/F controller 17. The DMAC 16 transfers the user data by a direct memory access (DMA) method.

The NAND I/F controller 17 is an interface device for accessing of the NAND memory 20. The NAND I/F controller 17 exchanges information, including user data, to and from the NAND memory 20 under the control of the CPU 11. The NAND I/F controller 17 can perform error correction processing on the user data.

The NAND memory 20 is a nonvolatile storage medium. The NAND memory 20 may include one or more chips. The NAND memory 20 includes a memory cell array. In addition, the memory cell array includes a large number of physical blocks. The physical block functions as an erase unit. That is, data is erased in minimum size units of a physical block.

The DRAM I/F controller 18 is connected to the DRAM 30 and controls communication between the memory controller 10 and the DRAM 30. The DRAM I/F controller 18 is configured based on a DRAM interface standard or the like.

The accelerator 19 controls command processing in cooperation with the CPU 11.

Various described functions of the host I/F controller 12, the NAND I/F controller 17, and the DRAM I/F controller 18 may be provided in the CPU 11 in some examples.

The DRAM 30 is a volatile memory. The DRAM 30 stores, for example, parameters for managing the NAND memory 20, various management tables, and the like. In addition, the DRAM 30 may include one or more chips.

As a comparative example, there is an SSD in which a host can designate a position by a logical address (as opposed to a physical address) in order to maintain compatibility with a hard disk drive (HDD). According to the SSD of this comparative example, the host designates an access destination by using a logical block address (LBA) for the SSD. In contrast, in the memory system 1 according to the present embodiment, the host 2 can designate a data object instead of a logical address. In this context, a data object can be a data bit of any size that is identified by a unique data object ID. A data structure and parameters thereof can be defined by the host 2 that uses the data object(s).

In the present embodiment, the memory system 1 assigns a unique ID to each data object stored therein. This unique ID is also referred to as a data object ID. A storage position (location) of the data object is managed by tables of a plurality of layers such that the memory system 1 can obtain a physical address indicating a position in the NAND memory 20 at which the data object corresponding to the data object ID is stored. For example, the memory controller 10 stores these tables in the DRAM 30 to refer to and update these tables on the DRAM 30 as necessary. In addition, the memory controller 10 also stores these tables in the NAND memory 20 at some predetermined timing or interval, so that these tables can be prevented from being lost from the memory system 1. The various management tables stored in the NAND memory 20 can also be referred to and updated as necessary.

FIG. 2 is a schematic diagram illustrating the tables for managing a storage position of the data objects. The tables are stored in the DRAM 30 according to the present embodiment. According to this example, the DRAM 30 stores an object information table 301 (sometimes abbreviated as OIT 301), an object allocation table 302 (sometimes abbreviated as OAT 302), and a look up table 303 sometimes abbreviated as LUT 303. Each of the tables stored in the DRAM 30 may not necessarily be a complete table, but rather a portion of full tables stored in the NAND memory 20 or the like. That is, these tables (301, 302, 303) in DRAM 30 may be cached data portions of the full tables stored in NAND memory 20 or the like. Information in these tables (301, 302, 303) stored in the DRAM 30 is associated with or linked to each other, so that data corresponding to a data object designated by the host 2 can be stored (written) in the NAND memory 20 and then read from the NAND memory 20.

The OIT 301 functions as a table of a first layer among the tables. The OAT 302 functions as a table of a second layer among the tables. The LUT 303 functions as a table of a third layer among the tables.

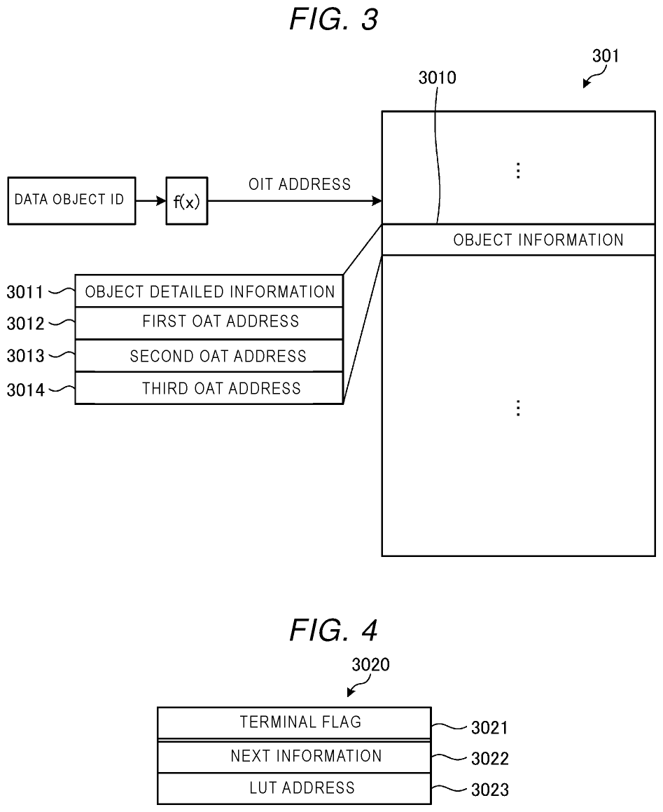

The OIT 301 will be described with reference to FIG. 3. The OIT 301 is a table in which object information 3010 is recorded for each individual data object. The object information 3010 is also referred to as “OI” or OI 3010. A position of each piece of the object information 3010 in the OIT 301 corresponds to the data object ID for the data object on a one-to-one basis. That is, the OIT 301 can search the object information 3010 based on the data object ID.

The memory controller 10 acquires an address indicating the position of the object information 3010 in the OIT 301 by performing a conversion on the data object ID by using a predetermined conversion function f(x). This address is referred to as an “OIT address”. The memory controller 10 acquires the object information 3010 at the position indicated by the OIT address in the OIT 301. A conversion method for obtaining the OIT address from the data object ID is not limited to any specific method.

The object information 3010 includes object detailed information 3011, a first OAT address 3012, a second OAT address 3013, and a third OAT address 3014.

The object detailed information 3011 includes information such as a status or an attribute of the data object.

Specifically, the object detailed information 3011 includes whether the data object has been deleted, a size of the data object, a namespace designated by the host 2 as a storage destination for the data object, whether overwriting of the data object is prohibited, whether the reading of the data object is prohibited, and/or whether the data object corresponds to stream data that may be continuously and sequentially input. The information included in the object detailed information is not limited these examples.

The first OAT address 3012 and the second OAT address 3013 are addresses indicating destinations in the OAT 302, which is the table of a second layer. OAT information is recorded for each data object in the OAT 302. Data constituting the data object is divided in units of a particular size (for example, sector units). A portion of the divided data is an example of first partial data. When the data object can be stored in the NAND memory 20 without being divided into multiple portions (units), then just one piece of OAT information is recorded in the OAT 302 for the data object. However, when the data object is divided into a plurality of parts and stored in the NAND memory 20 as such, then two or more pieces of OAT information are recorded in the OAT 302 for the data object.

When two or more pieces of OAT information are recorded in the OAT 302 for one data object, the two or more pieces of OAT information constitute a list structure. The first OAT address 3012 indicates a position of the head OAT information among the pieces of OAT information constituting the list structure. The second OAT address 3013 indicates a position of the end OAT information, in other words, terminal OAT information, among the pieces of OAT information constituting the list structure. The OAT information is an example of an entry.

When a piece of OAT information is recorded in the OAT 302 for a data object and an additional write command will not be executed on the data object, the second OAT address 3013 may be omitted. In addition, for a data object having a size of 0, then an invalid data value, for example, NULL, may be included in the object information 3010 as the second OAT address 3013.

The third OAT address 3014 is an address at which metadata that is information/data other than the information stored in the object detailed information 3011 of the data object can be stored. The metadata of a data object is information associated with the data object but not a part of the data within the data object. For example, metadata may be information indicating a creation date and time for the data object.

FIG. 4 is a schematic diagram illustrating an example of a data structure of a piece of OAT information 3020 according to the embodiment. The OAT information 3020 includes a terminal flag 3021, NEXT information 3022, and a LUT address 3023.

The terminal flag 3021 is flag information indicating whether the OAT information 3020 corresponds to the terminal OAT information. The NEXT information 3022 is an address indicating a position of the next OAT information 3020 (when there is the next OAT information 3020) in the list structure. The LUT address 3023 is an address indicating a position of an entry in the LUT corresponding to the OAT information 3020.

The LUT 303 is a table in which a physical address indicating a position in the NAND memory 20 at which the data constituting the data object is stored. In the LUT 303, when the object data is divided into two or more pieces of partial data, the physical address indicating the storage position in the NAND memory 20 is recorded in the LUT 303 for each piece of partial data, and each such position is indicated by the LUT address of the corresponding OAT information 3020.

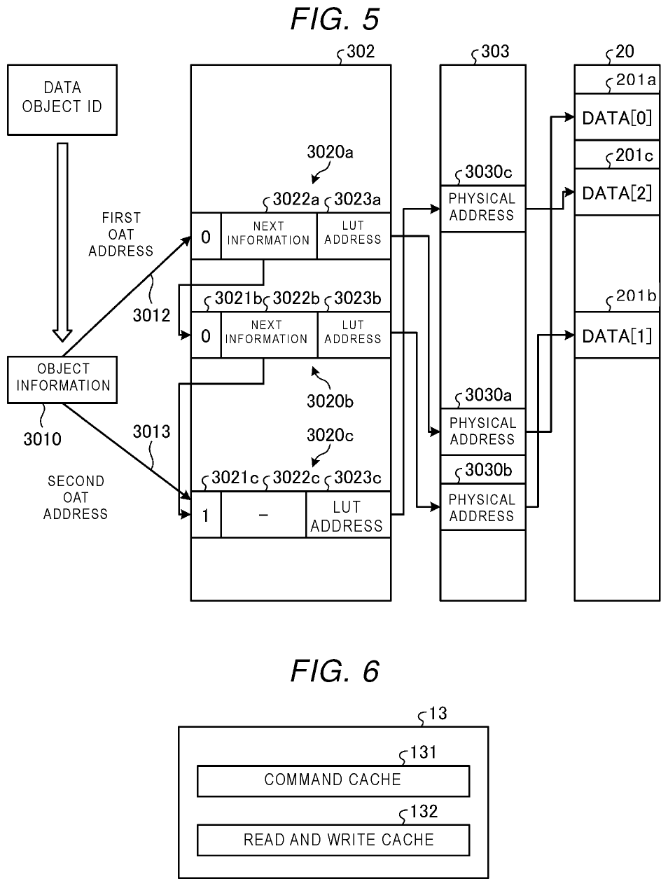

Next, a method for specifying data of a data object corresponding to the object information 3010 based on the data object ID will be described with reference to FIG. 5. It is assumed in this example that the data object is divided into three pieces of partial data and stored in the NAND memory 20. OAT information 3020a, OAT information 3020b, and OAT information 3020c correspond to the three pieces of partial data. NEXT information 3022a of the OAT information 3020a indicates a position of the OAT information 3020b. The NEXT information 3022b of the OAT information 3020b indicates a position of the OAT information 3020c.

The memory controller 10 first acquires the address indicating the position of the object information 3010 corresponding to the data object ID of the data object in the OIT 301 by performing a predetermined conversion on the data object ID. The memory controller 10 refers to the first OAT address 3012 of the object information 3010, and then refers to the OAT information 3020a at a position indicated by the first OAT address 3012 in the OAT 302. The memory controller 10 refers to a LUT address 3023a in the OAT information 3020a. The memory controller 10 refers to a physical address 3030a at a position indicated by the LUT address 3023a, and reads data 201a (“DATA [0]”) at the physical address 3030a in the NAND memory 20.

The memory controller 10 then refers to the NEXT information 3022a in the OAT information 3020a, and then refers to the OAT information 3020b at the position indicated by the NEXT information 3022a. The memory controller 10 refers to a LUT address 3023b in the OAT information 3020b. The memory controller 10 refers to a physical address 3030b at a position indicated by the LUT address 3023b, and reads data 201b (“DATA [1]”) at the physical address 3030b in the NAND memory 20.

The memory controller 10 then refers to the NEXT information 3022b in the OAT information 3020b, and then refers to the OAT information 3020c at the position indicated by the NEXT information 3022b. The memory controller 10 refers to a LUT address 3023c in the OAT information 3020c. The memory controller 10 refers to a physical address 3030c at a position indicated by the LUT address 3023c, and reads data 201c (“DATA [2]”) at the physical address 3030c. In addition, since a terminal flag 3021c is “1”, the address is NULL in the NEXT information 3022c, and the information indicated by the second OAT address 3013 is the OAT information 3020c, the data corresponding to the object information 3010 is obtained by combining the data 201a to 201c. That is, the data object uses the data 201a as start data and the data 201c as end data.

Next, an area allocated in the SRAM 13 will be described with reference to FIG. 6. As shown in FIG. 6, a command cache 131 and a read and write cache 132 are allocated in the SRAM 13. The command cache 131 is an area for caching commands before execution. The CPU 11 interprets a command stored (cached) in the command cache 131 and then executes control based on the interpretation of the command. The command cached in the command cache 131 can be a read command, a write command, an additional write command, a remove command, or a format command.

The read command is a command requesting reading of a data object corresponding to a data object ID received from the host 2. The write command is a command for requesting writing of a data object received from the host 2 to the NAND memory 20. The additional write command is a command for adding data to an end of a previously written data object. The remove command is a command for deleting a data object. The format command is a command for deleting data objects corresponding to a namespace.

The read and write cache 132 is a data area in which a part of the data also stored in the NAND memory 20 can be cached. In addition, the read and write cache 132 is a data area in which data received from the host 2 to be written to the NAND memory 20 can be cached.

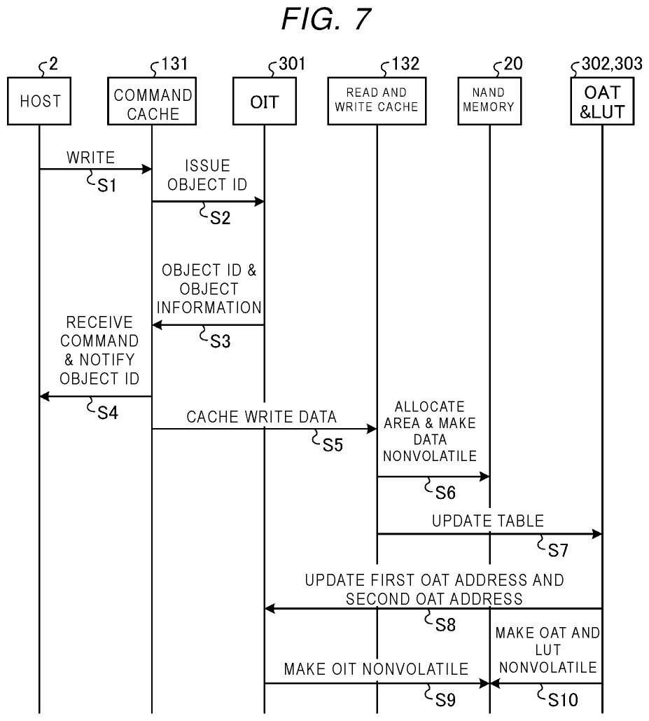

FIG. 7 is a sequence diagram illustrating an example of an operation in response to a write command in the memory system 1. The memory controller 10 receives the write command from the host 2 together with a data object to be written, and caches the write command in the command cache 131 (step S1). The memory controller 10 subsequently executes the write command in the command cache 131, accesses the OIT 301, and issues a new data object ID (step S2). The memory controller 10 acquires the address indicating the position of the object information 3010 in the OIT 301 by performing a predetermined conversion on the new data object ID, generates the object information 3010 at the corresponding address, and inputs the object information 3010 together with the data object ID to the command cache 131 (step S3).

The memory controller 10 notifies the host 2 that the command has been received and also notifies the host 2 of the assigned data object ID (step S4). The memory controller 10 caches the write data (the data to be written) in the read and write cache 132 (step S5). Then, the memory controller 10 allocates an area for writing the write data in the NAND memory 20, and writes the write data in the area to make the data nonvolatile (step S6). Here, making data or information nonvolatile means writing such data or information to the NAND memory 20. In some examples, the memory controller 10 may store the data of the data object in the NAND memory 20 such that the data of the data object is in continuous storage positions. In such a case, the memory system 1 can improve the processing efficiency for a subsequent reading of the data object. Furthermore, since the memory system 1 can erase an entire block of data in the NAND memory 20, writing of the data object to continuous storage positions may permit an erase efficiency of a data object to be improved.

Next, the memory controller 10 updates the LUT 303 to indicate the physical address corresponding to the write position of the written data. The memory controller 10 updates the information of the OAT information 3020 of the OAT 302 based on the updated physical address in the LUT 303 (step S7). Regarding the OAT information 3020 for the portion of the write data that is not end portion data of the data object, the memory controller 10 generates OAT information 3020 in which the terminal flag 3021 value is “0”, the NEXT information 3022 is an address of the OAT information 3020 for the next portion of the data of the data object, and the LUT address 3023 is the corresponding LUT address. For the OAT information 3020 of end portion data of the write data, the memory controller 10 generates OAT information 3020 in which the terminal flag 3021 value is “1”, the NEXT information 3022 is NULL, and the LUT address is for the end portion data.

The memory controller 10 updates the first OAT address 3012 based on the address of the OAT information 3020 for the head data of the write data, and updates the second OAT address 3013 based on the address of the OAT information 3020 for the end portion data of the write data (step S8).

Next, the memory controller 10 makes the OIT 301 nonvolatile by storing the OIT 301 in the NAND memory 20 (step S9). In addition, the memory controller 10 makes the OAT 302 and the LUT 303 nonvolatile by storing the OAT 302 and the LUT 303 in the NAND memory 20 (step S10).

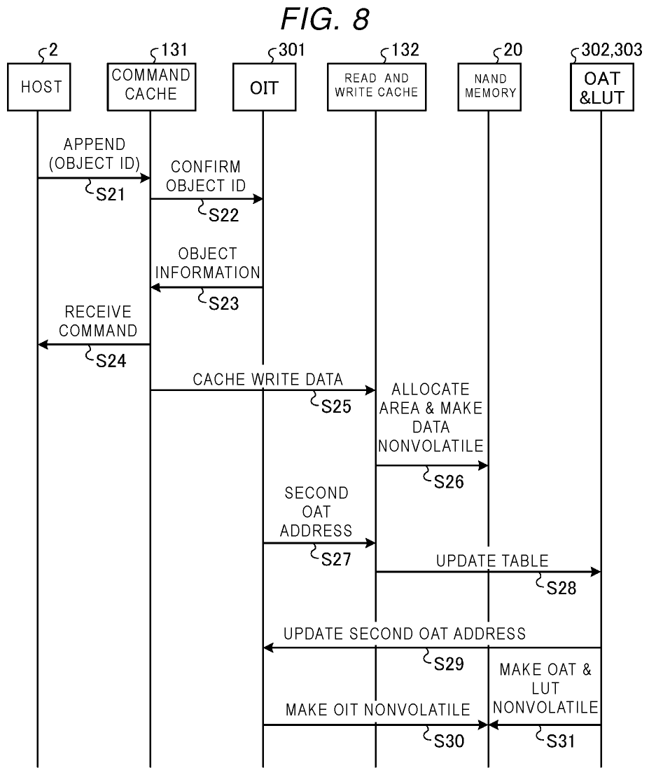

FIG. 8 is a sequence diagram illustrating an example of an operation in response to an additional write command (also referred to as an append command) in the memory system 1.

The memory controller 10 receives the append command from the host 2 together with additional data (that is, data to be added to a previously written data object) and a data object ID. The memory controller 10 caches the append command in the command cache 131 (step S21). The additional data is an example of second partial data. The memory controller 10 executes the additional write command in the command cache 131, converts the data object ID received from the host 2, and acquires the OIT address in the OIT 301 of the object information 3010 related to the data object to which additional data is to be appended (step S22). Then, the memory controller 10 acquires the object information 3010 from the position indicated by the OIT address

The memory controller 10 notifies the host 2 that the command has been received (step S24). The memory controller 10 caches write data (the additional data in this example) in the read and write cache 132 (step S25). Then, the memory controller 10 allocates an area into which the write data will be recorded in the NAND memory 20, and then writes the write data to the area (step S26).

The memory controller 10 acquires the second OAT address 3013 of the object information 3010 (step S27). The memory controller 10 updates a physical address indicating a position of end data of additional data in the LUT 303. The memory controller 10 generates OAT information 3020 for the end portion data that includes the updated LUT address 3023 in LUT 303 and the terminal flag 3021 value is set to “1”. Then, the memory controller 10 updates the terminal flag 3021 value of the OAT information 3020 corresponding to the second OAT address 3013 to “0”, and updates the NEXT information 3022 to the address of the OAT information 3020 including the LUT address 3023 for the additional data (step S28). In addition, the memory controller 10 updates the second OAT address 3013 of the object information 3010 (step S29).

Next, the memory controller 10 makes the OIT 301 nonvolatile by storing the OIT 301 in the NAND memory 20 (step S30). In addition, the memory controller 10 makes the OAT 302 and the LUT 303 nonvolatile by storing the OAT 302 and the LUT 303 in the NAND memory 20 (step S31).

The memory controller 10 can add data to a data object by executing an additional write command (append command), and can thus combine and manage continuously output data, such as the stream data, from the host 2.

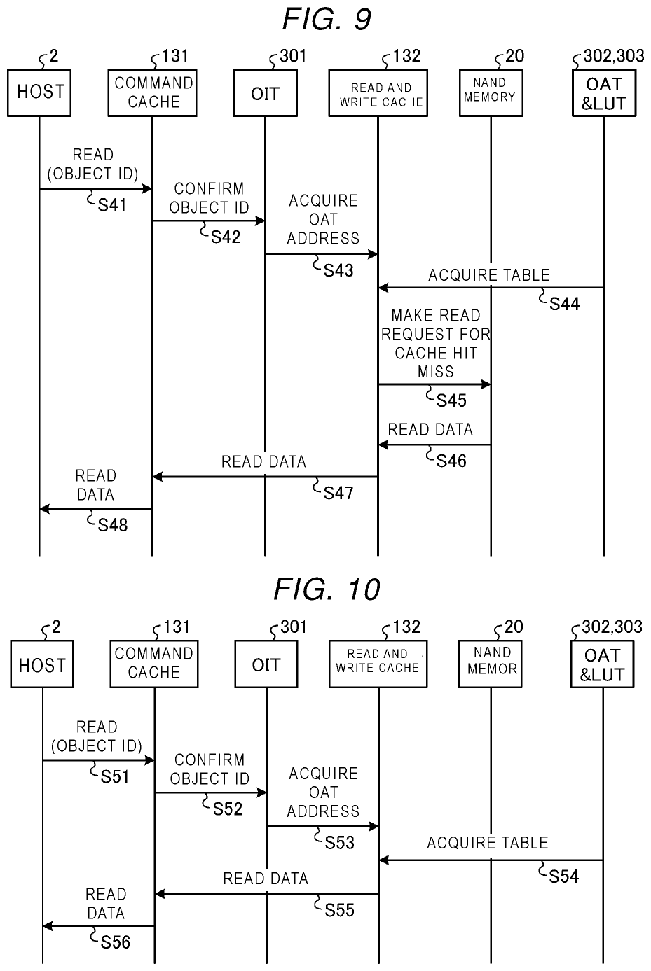

FIG. 9 is a sequence diagram illustrating an example of an operation in response to a read command in a case of a cache hit mistake in the memory system 1. The read command is a command for outputting a data object corresponding to a data object ID to the host 2.

The memory controller 10 receives the read command from the host 2 together with a data object ID of a data object to be read, and caches the read command in the command cache 131 (step S41). The memory controller 10 subsequently executes the read command and acquires the OIT address by performing a predetermined conversion on the data object ID received from the host 2 (step S42). The memory controller 10 acquires the first OAT address 3012 and the second OAT address 3013 in the object information 3010 indicated by the OIT address (step S43). The memory controller 10 acquires the OAT 302 and the LUT 303 corresponding to the first OAT address 3012 and the second OAT address 3013 (step S44).

In the case of the cache hit mistake (that is, the requested data object is not presently cached), the memory controller 10 must access the NAND memory 20 to make a read request (step S45) and acquire read data corresponding to the data object ID (step S46). Then, the memory controller 10 outputs the read data to the host 2 (steps S47 and S48).

FIG. 10 is a sequence diagram illustrating an example of an operation in response to a read command in a case of a cache hit in the memory system 1.

The memory controller 10 receives the read command from the host 2 together with the data object ID of the data object to be read, and caches the read command in the command cache 131 (step S51). The memory controller 10 subsequently executes the read command and acquires the OIT address by performing a predetermined conversion on the data object ID received from the host 2 (step S52). The memory controller 10 acquires the first OAT address 3012 and the second OAT address 3013 of the object information 3010 by acquiring the object information 3010 indicated by the OIT address (step S53). The memory controller 10 acquires the OAT 302 and the LUT 303 corresponding to the first OAT address 3012 and the second OAT address 3013 (step S54).

In the case of the cache hit, the memory controller 10 outputs data corresponding to the data object ID stored in the cache to the host 2 (steps S55 and S56). That is, since the data object was cached, there is no need to access the NAND memory 20 to acquire (read) the data object corresponding to the data object ID received from the host 2.

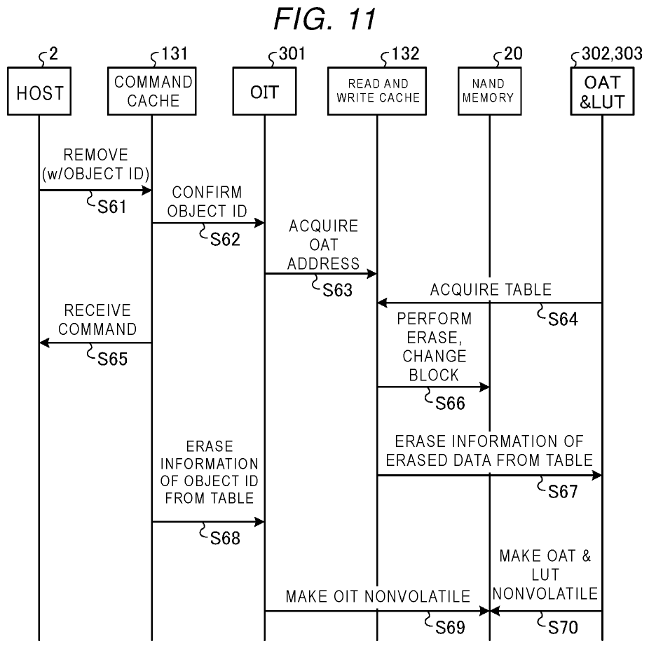

FIG. 11 is a sequence diagram illustrating an example of an operation in response to a remove command in the memory system 1.

The memory controller 10 receives a remove command from the host 2 together with the data object ID of the data object to be removed, and caches the remove command in the command cache 131 (step S61). The memory controller 10 then executes the remove command of the command cache 131 and acquires the OIT address by performing a predetermined conversion on the data object ID received from the host 2 (step S62). The memory controller 10 acquires the first OAT address 3012 and the second OAT address 3013 of the object information 3010 indicated by the OIT address (step S63). The memory controller 10 acquires table information of the OAT 302 and the LUT 303 corresponding to the first OAT address 3012 and the second OAT address 3013 (step S64).

The memory controller 10 notifies the host 2 that the command has been received (step S65). The memory controller 10 refers to the OAT 302 and the LUT 303 corresponding to the first OAT address 3012 and the second OAT address 3013, erases data of the OAT 302 and the LUT 303 corresponding to the data object ID, and changes a block storing the erased data to a free block (step S66). Here, the free block is a block that does not include valid data. The method shown in FIG. 5 is, for example, applied to a method for specifying the data corresponding to the data object ID by referring to the OAT 302 and the LUT 303 corresponding to the first OAT address 3012 and the second OAT address 3013. That is, the memory controller 10 identifies the data corresponding to the data object ID by referring to the OAT information 3020 corresponding to the first OAT address 3012 and the second OAT address 3013.

In addition, the memory controller 10 erases the OAT information 3020 of the erased data and the information of the LUT 303 (step S67). The memory controller 10 also erases the object information 3010 corresponding to the data object ID (step S68). Next, the memory controller 10 makes the OIT 301 nonvolatile by updating the OIT 301 in the NAND memory 20 (step S69). In addition, the memory controller 10 makes the OAT 302 and the LUT 303 nonvolatile by updating the OAT 302 and the LUT 303 in the NAND memory 20 (step S70).

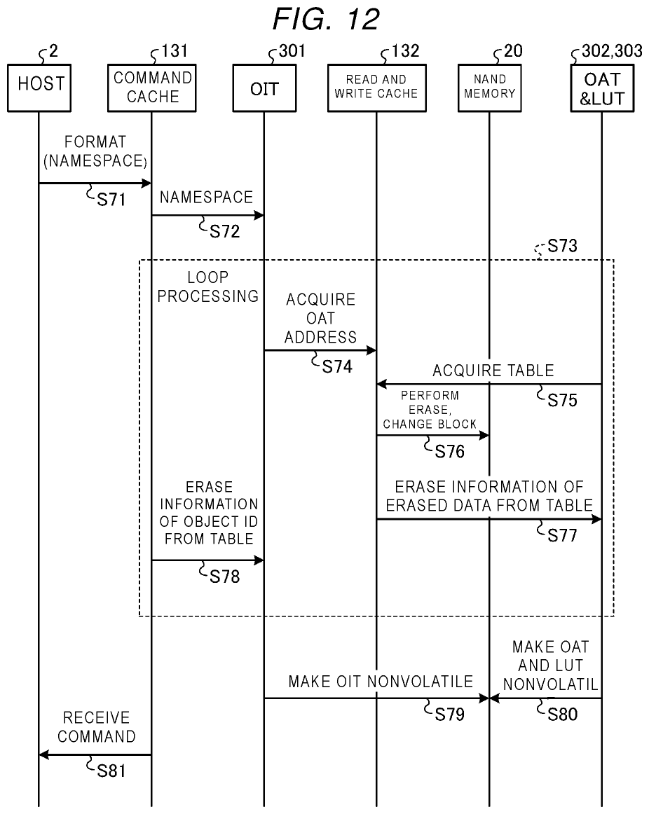

FIG. 12 is a sequence diagram illustrating an example of an operation in response to a format command in the memory system 1. The format command is a command for erasing all the data objects belonging to a designated namespace.

The memory controller 10 receives a format command request from the host 2 together with data indicating a namespace to be formatted and caches the format command in the command cache 131 (step S71). The memory controller 10 then executes the format command in the command cache 131, accesses the OIT 301, and identifies a data object ID including the namespace to be formatted in the object detailed information in the object information 3010 (step S72). The memory controller 10 erases the data object corresponding to the identified data object ID. The memory controller 10 executes loop processing corresponding to the number of the data object IDs of the data objects to be erased (step S73). That is, the memory controller 10 performs processing to erase each data object identified as corresponding to the designated namespace being formatted. The memory controller 10 executes processing of steps S74 to S78 in the loop processing. The processing of steps S74 to S78 is the same as processing of steps S63, S64, S66, S67, and S68 shown in FIG. 11, respectively.

When the loop processing S73 is ended, the memory controller 10 makes the OIT 301 nonvolatile by updating the OIT 301 in the NAND memory 20 (step S79). In addition, the memory controller 10 makes the OAT 302 and the LUT 303 nonvolatile by updating the OAT 302 and the LUT 303 in the NAND memory 20 (step S80). Then, the memory controller 10 notifies that the command has been received (step S81).

Next, processing associated with a master boot record (MBR) will be described. The master boot record is data in which a program or other information necessary for accessing the memory system 1 is stored. The host 2 first transmits a Get MBR command to the memory system 1. The Get MBR command is a command for acquiring a data object ID of a master boot record.

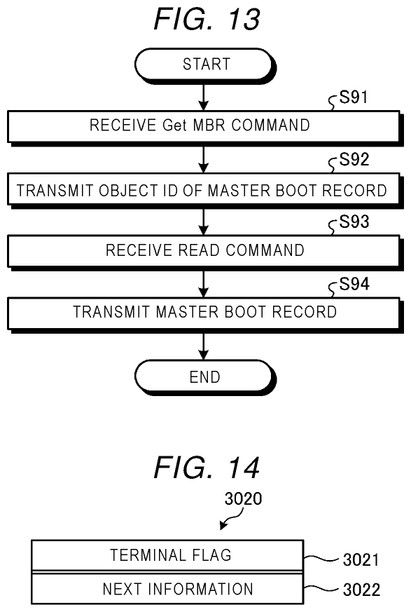

FIG. 13 is a flowchart illustrating an example of control related to the master boot record (MBR). In this example, it is assumed that a plurality of master boot records having different security levels have been stored in the NAND memory 20. The memory system 1 switches which master boot record to be output to the host 2 according to a setting state. For example, when the NAND memory 20 is locked by a security function of the memory system 1, the memory controller 10 transmits a master boot record having a high security level. That is, for example, when a password authentication is not completed at the time of starting up the host 2 a high security level or restricted access MBR is provided to the host 2. However, if host 2 successfully completes password authentication or the like, the memory controller 10 transmits a master boot record having a low security level (e.g., permitting unrestricted access).

When the memory controller 10 receives the Get MBR command from the host 2 (step S91), the memory controller 10 transmits data object ID(s) of the master boot records to be output to the host 2 according to the security level (step S92).

Next, the memory controller 10 receives a read command from the host 2 designating a data object ID output in step S92 (step S93). The memory controller 10 reads the master boot record corresponding to the received data object ID based on read processing shown in FIG. 9 or 10, and transmits the master boot record to the host 2 (step S94).

(Modification)

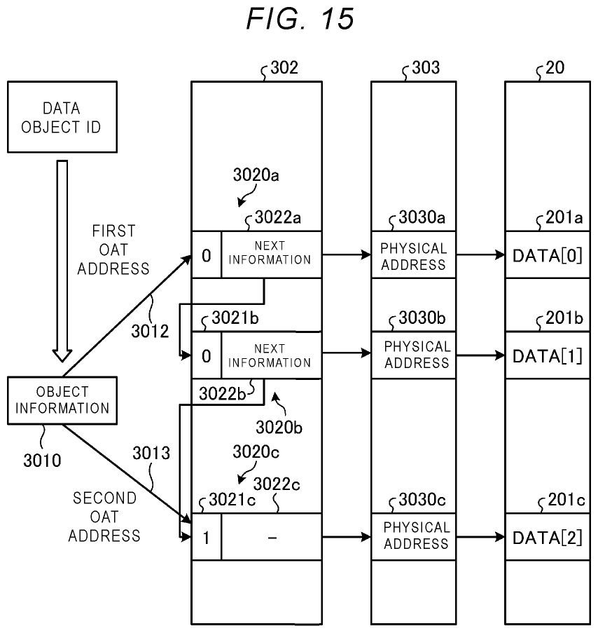

In the embodiment described above, the OAT information 3020 as described with reference to FIG. 5 includes the LUT address 3023. Alternatively, as shown in FIG. 14, the OAT information 3020 need not include the LUT address 3023. For example, a storage order in the OAT 302 in the OAT information 3020 and a storage order in the LUT 303 in the information in the LUT 303 corresponding to the OAT information 3020 may match or otherwise correspond to each other.

FIG. 15 illustrates a method for specifying the data of the data object corresponding to the object information 3010 based on the object information 3010. The memory controller 10 refers to the first OAT address 3012 of the object information 3010 and refers to the OAT information 3020a stored at the address indicated by the first OAT address 3012. The method for specifying the OAT information 3020 corresponding to the data object ID by using the NEXT information 3022a to the NEXT information 3022c is the same as the method described with reference to FIG. 5.

The memory controller 10 specifies the physical addresses 3030a to 3030c stored in the LUT 303, which correspond to the OAT information 3020a to the OAT information 3020c, by referring to the storage order in the OAT 302 of the OAT information 3020 and the information of the corresponding LUT table.

In the above description, the memory system 1 generates a data object ID to be written in response to the write command, and transmits the data object ID to be written to the host 2. In addition, the memory system 1 stores the data object in the NAND memory 20. Furthermore, the memory system 1 stores the object information 3010, the OAT information 3020, and the LUT 303, which correspond to the data object ID, in the DRAM 30 and the NAND memory 20.

In this way, the memory system 1 can access the data object based on the data object ID designated by the host 2 by generating the data object ID, outputting the data object ID to the host 2, and then managing a correspondence between the data object ID and a storage position (or positions) of the data object in the NAND memory 20 by using a table. That is, the memory system 1 can perform processing in units of data objects.

In the memory system 1, a data object can be divided into multiple pieces of data and these pieces can be stored in the NAND memory 20, and the OAT information 3020 corresponding to the pieces of data are stored in the OAT 302. In the memory system 1, a data object to be written can be divided multiple pieces of data and then stored in the NAND memory 20. By storing the OAT information 3020 corresponding to the pieces of data, the data pieces constituting a data object may be written in parallel and can thus be written efficiently.

The memory system 1 may store the data constituting a data object in the NAND memory 20 such that the pieces of data constituting the data object are written at continuous (e.g., contiguous) storage positions. In this case, the memory system 1 can improve the processing efficiency of a subsequent reading of the data object. Furthermore, since the memory system 1 can erase an entire block, continuous data may be erased more efficiently.

When the memory system 1 receives an additional write command, the memory system 1 writes the data for the additional write to the NAND memory 20, and stores the OAT information 3020 corresponding to the data for the additional write. In this way, the memory system 1 can add data to a previously written data object. Accordingly, the memory system 1 can, for example, combine and manage continuously output data from the host 2 such as stream data.

The memory system 1 erases the data object corresponding to the data object ID received from the host 2 in response to a remove command. The memory system 1 can erase the data corresponding to the data object ID by identifying the data corresponding to the data object ID.

The memory system 1 can transmit the data object ID of a master boot record to the host 2 in response to a Get MBR command. The memory system 1 may then transmit the data object(s) of the master boot record to the host 2 in response to a read command designating the data object ID supplied to the host 2 in response to the Get MBR command.

In this way, even when the host 2 does not presently store the information of the master boot record, the memory system 1 can make a notification of the data object ID according to a request for the data object ID of the master boot record, and can thus output the master boot record to the host 2.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A memory system connectable to a host, the memory system comprising:
a nonvolatile memory; and
a controller configured to:
generate an identifier of a data object to be written in response to a write command from a host,
transmit the identifier to the host,
store the data of the data object in the nonvolatile memory, and
maintain a table providing a correspondence between the identifier and a storage position for the data of the data object in the nonvolatile memory.

2. The memory system according to claim 1, wherein
the controller is configured to divide the data object into two or more pieces of data and store the two or more pieces of data in the nonvolatile memory at two or more respective storage positions,
the table includes entries corresponding to each of the pieces of data, and
the entries corresponding to the each of the pieces of data constitute a list structure for the data object.

3. The memory system according to claim 1, wherein the controller is configured to store the data of the data object at continuous storage positions in the nonvolatile memory when the size of the data object exceeds the size of one storage position in the nonvolatile memory.

4. The memory system according to claim 1, wherein the controller is configured to store additional data in the nonvolatile memory as a piece of the data object in response to receiving the identifier of the data object and an additional write command together with the additional data, and then add a new entry in the table for the additional data.

5. The memory system according to claim 1, wherein the controller is configured to erase the data object corresponding to the identifier in response to receiving a remove command together with the identifier for the data object.

6. The memory system according to claim 1, wherein the controller is further configured to transmit, to the host, an identifier of a data object corresponding to a startup program in response to receiving a master boot record request command from the host.

7. The memory system according to claim 6, wherein the controller is further configured to read the data object corresponding to the startup program from the nonvolatile memory and then transmit, to the host, the data object corresponding to the startup program in response to receiving a read command together with the identifier of the data object corresponding to the startup program from the host.

8. The memory system according to claim 1, wherein the identifier is associated, in the table, with a namespace designated by the host for a plurality of data objects.

9. A memory system, the memory system comprising:
a host;
a nonvolatile memory; and
a controller connected to the host and configured to:
generate an identifier of a data object to be written in response to a write command from the host,
transmit the identifier to the host,
store the data of the data object in the nonvolatile memory, and
maintain a table providing a correspondence between the identifier and a storage position for the data of the data object in the nonvolatile memory.

10. The memory system according to claim 9, wherein
the controller is configured to divide the data object into two or more pieces of data and store the two or more pieces of data in the nonvolatile memory at two or more respective storage positions,
the table includes entries corresponding to each of the pieces of data, and
the entries corresponding to the each of the pieces of data constitute a list structure for the data object.

11. The memory system according to claim 9, wherein the controller is configured to store the data of the data object at continuous storage positions in the nonvolatile memory when the size of the data object exceeds the size of one storage position in the nonvolatile memory.

12. The memory system according to claim 9, wherein
the controller is configured to store additional data in the nonvolatile memory as a piece of the data object in response to receiving the identifier of the data object and an additional write command together with the additional data, and then add a new entry in the table for the additional data.

13. The memory system according to claim 9, wherein the controller is configured to erase the data object corresponding to the identifier in response to receiving a remove command together with the identifier for the data object.

14. The memory system according to claim 9, wherein the controller is further configured to transmit, to the host, an identifier of a data object corresponding to a startup program in response to receiving a master boot record request command from the host.

15. The memory system according to claim 14, wherein the controller is further configured to read the data object corresponding to the startup program from the nonvolatile memory and then transmit, to the host, the data object corresponding to the startup program in response to receiving a read command together with the identifier of the data object corresponding to the startup program from the host.

16. The memory system according to claim 9, wherein the identifier is associated, in the table, with a namespace designated by the host for a plurality of data objects.

17. A memory control method for a memory system connectable to a host, the memory control method comprising:
generating an identifier of a data object to be written to a non-volatile memory in response to a write command from a host;
transmitting the identifier to the host;
storing the data of the data object in the nonvolatile memory; and
maintaining a table providing a correspondence between the identifier and a storage position for the data of the data object in the nonvolatile memory.

18. The memory control method according to claim 17, wherein
the data object is divided into two or more pieces of data and the two or more pieces of data are stored in the nonvolatile memory at two or more respective storage positions,
the table includes entries corresponding to each of the pieces of data, and
the entries corresponding to the each of the pieces of data constitute a list structure for the data object.

19. The memory control method according to claim 17, wherein the data of the data object is stored at continuous storage positions in the nonvolatile memory when the size of the data object exceeds the size of one storage position in the nonvolatile memory.

20. The memory control method according to claim 17, wherein the identifier is associated, in the table, with a namespace designated by the host for a plurality of data objects.
